(19) United States
(12) Patent Application Publication
(10) Pub. No.: US 2011/0131396 A1
(43) Pub. Date: Jun. 2, 2011

(54) TIMING ANALYSIS

(75) Inventors: Michael David May, Bristol (GB); Hendrik Lambertus Muller, Bristol (GB)

(73) Assignee: XMOS Limited, London (GB)

(21) Appl. No.: 12/628,706

(22) Filed: Dec. 1, 2009

(51) Int. Cl. G06F 9/30

(52) U.S. Cl. 712/227; 712/220; 712/E09.016; 712/E09.032

(57) ABSTRACT

One aspect of the present invention provides processor comprising: an execution unit arranged to execute a sequence of instructions each comprising a respective opcode; and a counter coupled to the execution unit and arranged to generate a periodically updated counter value during execution. The execution unit comprises logic configured to identify an opcode representing a trap-if-late instruction in said sequence, and in response to execute the trap-if-late instruction by comparing a target value to the counter value and generating an exception on condition that the counter value represents a time that is late relative to said target value. Another aspect provides a compiler for inserting trap-if-late instructions based on timing constraints in higher-level code.

### FIELD OF THE INVENTION

The present invention relates to analysing the timing of code to be executed on a processor.

### BACKGROUND

A programmer may write a program that contains timing information. For instance, the programmer may specify that a while loop has to be executed at a certain rate, e.g. 48 KHz. Another example would be that a certain data channel should carry some specified amount of data per unit time, say N bytes of data every t nanoseconds. Another example would be that an event or occurrence A has to happen within a specified time t nanoseconds of another event or occurrence B, or a point in the code should be reached within a specified time of another point in the code.

The programmer includes the timing information explicitly in a high-level programming language (e.g. in C++ or a variant). A compiler then takes the high-level program and generates corresponding low-level machine code for execution on a processor (this may optionally involve a separate assembler stage). Conventionally, the compiler will check that the code it generates will execute under the required real-time metrics by applying static analysis. Static analysis will, for example, resolve the following case.

| while 48 Khz (true) { | |
|---|---|
| o <: signal; | // Output data. |
| signal = signal * 3; | // Compute new data. |
| } | |

In this example, the program outputs a data value (“signal”), multiplies the value by three, then loops back to the beginning of the loop in order to output the new multiplied value, multiply it by three again and so on. It is possible for the compiler to reliably analyze the timing of this loop using static analysis, because there is no dependency involved and so the compiler can make a precise estimate of the time required to complete the loop.

On the other hand, in cases where the time taken is data dependent, static analysis may use a worst-case metric to try to determine a time for the loop. For example, data dependency may occur where the code takes an input from an external source such as a temperature sensor, and the behavior of the program depends on the data from that external source. One example would be as follows.

```
while 48 Khz (true) {
  temperature sensor :> signal; // Input data.
  if (signal < 16) X;
  if (signal > 5) Y;
}
```

In this piece of code, the program inputs a data value from a temperature sensor, tests whether the value is smaller than 16 and if so performs a function X, then tests whether the value is greater than 5 and if so performs a different function Y. The time taken for each loop therefore depends on the inputted data. In any given instance, the time for the loop could be the time taken for X, the time taken for Y, or the time taken for X followed by Y. The worst-case metric is the latter; and if the time taken for X followed by Y, plus the time taken for the other instructions in the loop, fit with the 48 KHz time requirement, then the compiler will ‘pass’ the loop. Otherwise the compiler will generate a warning to the programmer, or possibly generate an error which halts the compilation.

### SUMMARY

A compiler using static timing analysis could ‘reject’ a program if the worst-case time does not fit. However, there are cases where the worst-case metric has no meaning, in that it represents a path through the code that, although logically possible, cannot happen because of patterns in the input data that are not known to the compiler. There may also be cases where the analysis by the compiler is too strict, e.g. where the pattern of input data in the worst-case scenario is statistically unlikely or would occur with a statistically tolerable frequency.

In order to accommodate such cases, one aspect of the present invention provides a compiler that can insert a run time check in the form of a “trap-if-late” instruction into the compiled program, to check at run-time whether timing constraints are met. Another aspect of the present invention provides a processor comprising logic configured to decode and execute an instruction set including the trap-if-late instruction.

More particularly, according to one aspect of the present invention there is provided a processor comprising: an execution unit arranged to execute a sequence of instructions each comprising a respective opcode; and a counter coupled to the execution unit and arranged to generate a periodically updated counter value during said execution; wherein the execution unit comprises logic configured to identify an opcode representing a trap-if-late instruction in said sequence, and in response to execute the trap-if-late instruction by comparing a target value to the counter value and generating an exception on condition that the counter value represents a time that is late relative to said target value.

In embodiments, said logic may be configured to determine the target value from an operand of said trap-if late instruction.

The identity of the counter may be implicit in the trap-if-late instruction. The trap-if-late instruction may have a single operand.

The counter may be arranged to generate a counter value representing time in discrete units of seconds or integer divisions of seconds.

Said logic may be configured to generate the exception at the point of execution of said trap-if-late instruction itself, on condition that the counter value represents a time that is late relative to said target value at that point of execution.

Said logic may be configured, in response to the trap-if-late instruction, to store said target value for subsequent comparison with the counter value, and to generate an exception at a later point in the code if a further operation has not been executed by that point.

The trap-if-late instruction may be a set-port instruction which sets a time register of a port to said target value such that a transfer of data involving said port will occur at a time corresponding to the target value.

Said further operation may comprise an output of data from said port.

The execution unit may be configured to execute an instruction set which includes: a first trap-if-late instruction, and a second trap-if-late instruction having a different opcode from the first trap-if-late instruction, wherein the second trap-if-late instruction may be a set-port instruction which sets a time register of a port to said target value such that a transfer of data involving said port will occur at a time corresponding to the target value.

Said logic may be configured to perform said comparison by means of an operation to determine whether the counter value is greater than said argument value.

Alternatively, said logic may be configured to perform said comparison by means of an operation to determine whether a signed difference between the counter value and the operand is greater than zero.

The processor may comprise a debugging port, wherein the processor may be arranged to output an indication of the exception via the debugging port, e.g. for detection at a separate computer terminal coupled to the debugging port.

According to another aspect of the present invention there may be provided a compiler product embodied on a computer-readable medium, the compiler being configured so as when run on a computer terminal to: receive higher-level code, and compile the high-level code to generate lower-level code; identify a timing constraint in said higher-level code; and in response to the identification of said timing constraint, insert a trap-if-late instruction into the lower-level code, the trap-if-late instruction comprising an opcode identifying the instruction as a trap-if-late instruction, the opcode being configured to operate an execution unit of a target processor to compare a target value to the counter value and generate an exception on condition that the counter value represents a time that is late relative to said target value.

In embodiments, the compiler may be configured to identify a timing constraint explicitly specified in the high-level code by a programmer, and to insert said trap-if-late instruction in response to the explicit timing constraint.

The compiler may be configured to detect whether a portion of said higher-level code qualified by said timing constraint is dependent on non-deterministic data, and to insert the trap-if-late instruction on condition of detecting that the portion is dependent on non-deterministic data.

According to further aspects of the invention, there may be provided a method of compiling and executing a program comprising trap-if-late instructions; and a system comprising a processor, test platform and host terminal for detecting exceptions generated by trap-if-late instructions.

In embodiments, the method or system may comprise steps or features in accordance with any of the above processor or compiler features.

### BRIEF DESCRIPTION OF THE DRAWINGS

For a better understanding of the present invention and to show how it may be carried into effect, reference is now made by way of example to the accompanying drawings in which:

FIG. 1a is a schematic block diagram of a system comprising a target processor, test platform and host terminal,

FIG. 1b is a schematic representation of a machine code instruction loaded into an instruction register, and

FIG. 2 is a schematic illustration of a processor of generating an executable program from source code.

### DETAILED DESCRIPTION OF PREFERRED EMBODIMENTS

According to preferred embodiments, the present invention provides a mechanism that enables the system designer to observe whether real time deadlines are met. The system designer can, on certain instructions, pass a target counter value (e.g. a time) to the instruction, and the instruction will trap if this target is late relative to some global counter (e.g. a wall clock).

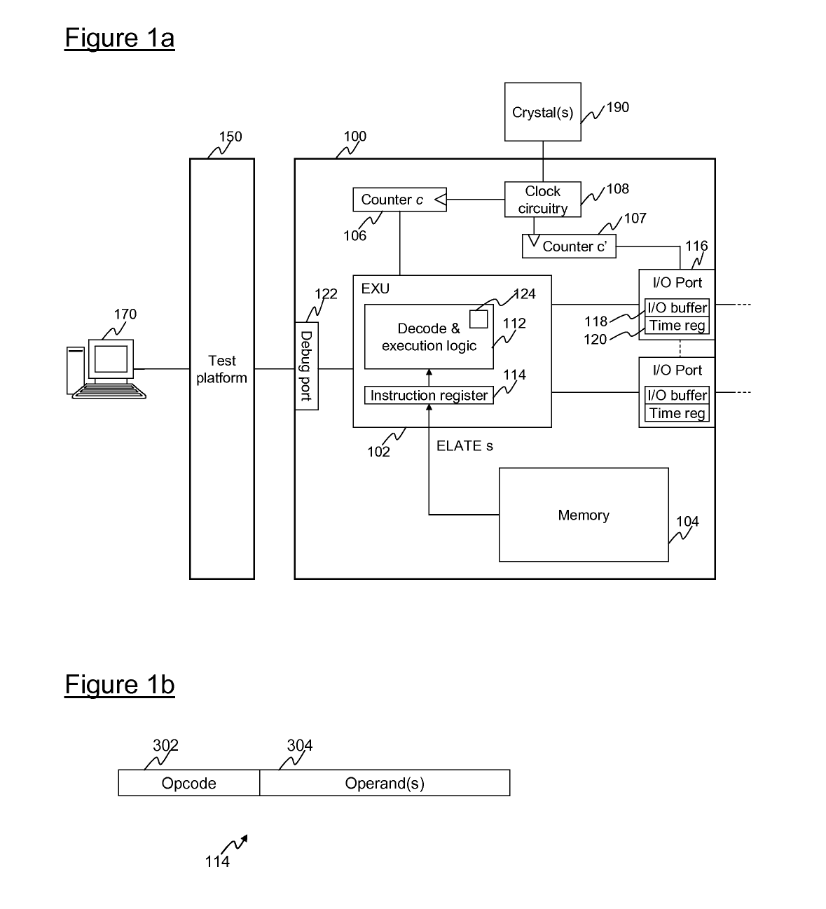

FIG. 1a is a schematic block diagram showing a system comprising a target processor 100, a test platform 150 and host computer terminal 170 according to an exemplary implementation of the present invention. The processor 100 comprises a debugging port 122 such as a JTAG (Joint Test Action Group) port. The debugging port 122 is coupled to the test platform 170, which is a unit into which the target processor 100 may be plugged or physically inserted. The test platform 170 comprises a complementary JTAG port or other debugging port, a computer port such as a USB (Universal Serial Bus) port, and a converter for converting between the JTAG and USB protocols or between other such protocols for the debugging and computer ports. The host terminal 170 is coupled to the USB port of the test platform 170 and thereby arranged to communicate with the target processor 100. The host terminal 170 is installed with compiler, assembler and linker software for generating executable machine code and downloading the executable code via the test platform 150 to the processor 100 for execution; and debugging software for receiving debugging information back from the target processor 100 via the test platform.

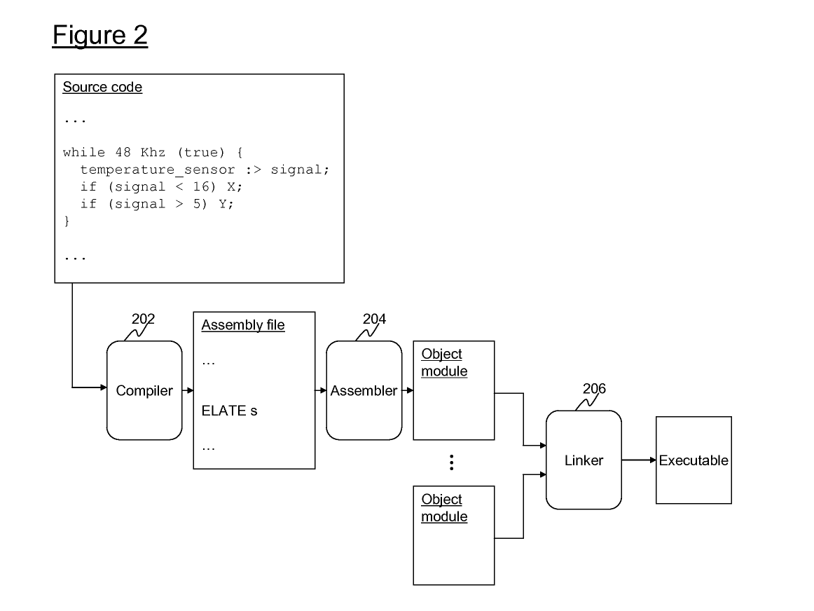

FIG. 2 schematically illustrates the compiler 202, assembler 204 and linker 206 as installed and run on the host terminal 170. In operation, the compiler 202 receives a file of source code written in a high-level language such as C++, and compiles it to generate an assembly file comprising lower-level assembly code. The compiler 202 may also insert additional linker information for use by a linker. The assembler 204 receives the assembly file from the compiler 202 and generates an object module. The object module comprises executable binary machine code, plus any additional linker information generated by the compiler 202. Alternatively the compiler 202 may output the object file directly without a separate assembly stage. The linker 206 receives the object file plus any other relevant object files required to form the final program, and uses the additional linker information to combine the object modules into a single executable file of binary machine code. For short programs, it is possible that no linking is required and the executable program is formed of a single object.

The compiler 202 is configured to determine where timing constrains occur within the source code. These are preferably timing constraints that are explicitly defined by the programmer using the high-level source code language, such as the “while 48 Hz” loop in the above examples. However, the possibility of detecting implicit or pre-determined timing constraints is not excluded.

Instead of relying on static analysis which tries to predict in advance whether timing constraints will be met without actually executing the program, according to preferred embodiments of the present invention the compiler 202 may insert “trap-if-late” instructions into the assembly file (or object file or executable if compiled directly). The trap-if-late instruction generates an exception at run time on condition that a timing constraint is not actually met during actual execution of the program, allowing for a dynamic checking of the program's timing requirements. This may be used in addition or as an alternative to static analysis. The trap-if-late instruction may be referred to herein as an ELATE instruction.

The ELATE instruction preferably has a single argument, s, which is a target time for the program at which the ELATE occurs. The argument s is compared against a wall clock c, and the processor 100 raises an exception if the current time at that point in the execution of the program is after s. The action of the ELATE instruction on the processor 100 will be discussed in more detail shortly.

In particularly preferred embodiments, the compiler 202 may be configured to analyse the portion of code qualified by the timing constraint in order to determine whether it is data dependent. That is, to determine whether the portion of code in question (the portion to which the timing restraint applies) is dependent on non-deterministic data which is input from or affected by any external or otherwise non-deterministic sources, such as the input from a temperature sensor in the second while loop example above. The compiler 202 may then only insert an ELATE instruction on condition that the qualified portion of code does contain a non-deterministic data dependency. If the qualified portion of code is purely deterministic on the other hand, e.g. in the first while loop example above, the compiler may assume that conventional static analysis is sufficient therefore not insert an ELATE. This advantageously avoids unnecessary extra machine code, which would increase the program's size and slow it down (potentially even causing the program to become late due to excessive ELATE instructions, when it might not have been late otherwise).

However, in alternative embodiments the compiler may insert ELATE instructions for non data dependent code as well. E.g. a cache miss could cause an unpredictable delay in an otherwise purely deterministic portion of code.

The action of the ELATE instruction on the target processor 100 is now discussed in more detail in relation to FIGS. 1a and 1b. The processor 100 comprises an execution unit 102, a memory 104 such as a flash memory or RAM coupled to the execution unit 102, a counter 106 having an output also coupled to the execution unit 102, and clock circuitry 108 coupled to a clock input of the counter 106. The execution unit 102 may be further coupled to the debug port 122. The execution unit 102 comprises an instruction register 114 coupled to the memory 104 via fetch circuitry (not shown), and decode and execution logic 112 coupled to the instruction register 114.

The clock circuitry 108 may comprise various components familiar to a person skilled in the art. For example, the clock circuitry would typically comprise a phase locked loop (PLL) arranged to generate a steady clock signal by reference to a reference oscillator 190, typically a crystal oscillator mounted on the same board as the processor chip 100. The reference oscillator frequency may be lower than the clock frequency to be generated, in which case the PLL multiples up the frequency.

The clock circuitry 108 may also comprise one or more clock dividers arranged to divide the master clock signal from the PLL and thus generate one or more other clock signals for clocking various different parts of the processor chip 100. The clock signal may be divided and/or branched multiple times throughout the chip 100.

The clock circuitry 108 is arranged to supply a periodic clock signal to the clock input of the counter 106, in the form of a regular alternating sequence of rising and falling logical transitions (“edges”). Whenever the clock input of the counter 106 detects one of the relevant edges of the clock signal (either a rising or filling edge), it is triggered to increment a counter value c held within the counter, thus representing an increase in time (a decrementing counter would also be an option in principle, although that would be less intuitive if the counter is to represent time). Thus the counter 106 provides a periodically updated measure of the passage of time, which is supplied to the execution unit 102. The counter 106 or its counter value c may be referred to herein as a “wall clock”, i.e. a reference time.

The counter 106 preferably measures time in what may be referred to as “human time”, i.e. in discrete units of seconds or some convenient integer division of seconds such as microseconds or nanoseconds. The crystal oscillator 190 used as a source for generating the clock signal which clocks the counter 108 may be the same crystal oscillator used as a source to generate the clock signal that clocks the execution unit 102 and other components on the processor 100. Such a crystal would typically have a frequency of the order of megahertz or gigahertz and may not have a period which multiplies conveniently to seconds or such like. In that case the clock circuitry 108 may require complex clock divider circuitry in order to clock the counter 106 in “human time”, or otherwise the counter may simply measure time in a more convenient units relative to the processor clock speed, e.g. in processor cycles or multiples thereof. Alternatively, the clock circuitry 108 on some processors may be connected an additional crystal oscillator 190 specifically included for measuring human time. This second oscillator and associate clock circuitry is sometimes referred to as a “real-time clock” (RTC). Real-time reference oscillators typically have a frequency of an integer power of two oscillations per second, i.e. 2ⁿ oscillations per second where n is an integer, because this is most convenient for dividing down to a unit of one second. Most common is 32.786 kHz, which is 2¹⁵ oscillations per second.

The execution unit 102 fetches a sequence of instructions in turn from the memory 104. FIG. 1b illustrates schematically the format of an instruction, shown loaded into the instruction register 114. As shown in FIG. 1b, each instruction comprises an opcode 302 and (for most types of instruction) one or more operands 304. The opcode identifies the type of the instruction, i.e. the type of the operation to be performed (e.g. ADD, SHIFT LEFT, GOTO, ELATE, etc.); and the operands indicate any relevant arguments of that instruction (e.g. the values on which to operate, or a destination register to store a result of the operation). An operand may be an immediate operand contained directly in the operand portion 304 of the instruction itself (i.e. the operand is the value of the argument), or may it be a specifier of a register containing a value for use in the operation (so that the operand specifies where to find the argument's value).

The decode and execution logic 112 is configured to read the opcode and any associated operands of an instruction from the instruction register 114, to decode their meaning, and to execute the instruction by performing the operation identified by the opcode using the argument or arguments indicated by the one or more operands.

The instruction set of a processor 100 refers to the set of instructions that its execution unit 102 is configured to recognise and execute. This is sometimes referred to as the “instruction set architecture”, since it is an intrinsic property of the processor 100 itself: it is the set of the types and formats of machine code instruction that the processor is configured to recognise and act upon (as opposed to a program which is a sequence of instances of such instructions). For example, if the instruction register (and therefore each instruction) is sixteen bits long, and five of those bits are the opcode, then the execution unit 102 must comprise decoding logic which “knows” that, say, the opcode 01011 means ADD, the opcode 11010 means SHIFT LEFT, etc.; and also knows the format of the operand portions in the rest of each instruction and which operands they correspond to (e.g. source register, destination register, etc.). The execution unit must also comprise execution logic configured to act upon each decoded instruction by performing the corresponding operation. The instruction set architecture may be implemented in dedicated hardware logic in the execute and decode logic 112, or sometimes using a soft instruction set whereby the execute and decode logic 112 refers to a programmable look-up table.

Referring to the exemplary embodiment of FIG. 1a, according to the present invention the execute and decode logic 112 of the execution unit 102 comprises a special instruction set architecture configured to recognise and act upon a special, dedicated “trap-if-late” instruction, ELATE, which is identified in the instruction set architecture by a specific combination of opcode bits. That is, the nature of the ELATE instruction is an intrinsic property of the processor's instruction set architecture (rather than being a function created by a programmer using multiple generic instructions from a conventional, generic instruction set).

As mentioned, the ELATE instruction preferably takes a single argument (indicated by a single opcode, which could be either an immediate operand containing the argument value directly or a register specifier identifying a register in which the argument value is stored). The argument s represents a target time relative to the counter value c by which the processor 100 should have reached the point in the code at which the ELATE instruction has been inserted. That is, the ELATE instruction detects whether the point in the program at which that single ELATE instruction itself occurs is late, and if so the exception is generated at the point of execution of the ELATE instruction. The identity of the counter 106 is preferably implicit in the ELATE instruction. “Implicit” in the context of an instruction set architecture means no operand required for that purpose. Thus the instruction format is:

### ELATE s

The execute and decode logic 112 contains special trap-if-late logic 124 configured to perform the “trap if late” operation using the argument s and implicitly the counter value c, as follows.

As mentioned, the argument s is compared against the wall clock c, and the processor raises an exception if the argument the current time is after s. The comparison is performed at the current time, at current point of execution in the code, thus enabling late timing problems to be trapped at run-time.

The “after” relationship may be dependent on the type and range of s and c. Note that on the mathematical domain of integers c>s≡(c−s)>0. However, computer arithmetic typically uses a limited number of bits to represent a number in the range [−2ⁿ . . . 2ⁿ−1], in which case the above identity does not hold, and hence a decision has to be made as to whether to use the left form (c>s) or the right form (c−s>0).

If s and c can represent a large values such as hundreds of years for example, then the after relationship is preferably defined as a “greater than” operation, i.e. c>s. Two examples of this are a 64-bit timer that counts nanoseconds, or a 32-bit counter that counts seconds.

If s and c cannot represent a large value on the other hand, and c has the potential to wrap around, then the “after” relationship is preferably defined instead as the signed difference being greater than zero, i.e. (c−s)>0. An example of this is a 32-bit counter that counts nanoseconds, which will wrap around every four seconds.

A trap is an exception that is raised synchronously with the execution of the code, as opposed to something generated in response to an asynchronous event such as an external interrupt. When an ELATE instruction determines that its point in the code is late, then depending on the implementation of the present invention there may be a number of different options for trap handler actions.

For example, the trap-if-late logic 124 could be configured to branch to some predetermined exception handling routine. The exception handling routine may for example output a signal indicating the exception to the host terminal 117 via the debug port 122 and test platform 150; or may take steps to address the timing problem, e.g. by prioritising the scheduling of the late procedure in a real-time operating system (RTOS) scenario. Alternatively, the trap-if-late logic 124 could contain dedicated hardware for handling the exception, e.g. which is configured to output a signal indicating the exception directly from the debug port 122, or perhaps even halts execution.

In a particularly preferred embodiment, the trap-if-late logic 124 is configured to save the current program state upon raising an exception before branching to an exception handling routine, so that that the program state can be restored again once the trap handling routine has completed. Such program state information could include for example a program counter, global pool pointer, data pointer, stack pointer and/or link register, etc. In a multi-threaded environment, the program state could also include status register values for individual threads, e.g. which record whether each thread is enabled to respond to external events.

In further embodiments of the present invention, the instruction set architecture may alternatively or additionally be configured to decode and execute another type of trap-if-late instruction which may be referred to herein as a “set port” instruction or SETPT. It takes two arguments as follows.

### SETPT r, s

Referring again to FIG. 1a, the processor 100 may comprise one or more Input & Output (I/O) ports 116. Each port 116 has a respective I/O buffer 118 and a trigger time register 120 associated with it. Each port 116 is also coupled to the output of the counter 106, and comprises logic configured to detect when the counter value c matches the trigger time value. When the match is detected, and the port is suitably set, the port will be triggered to perform either an input or an output operation. In the case of an input operation, this means capturing data from the exterior of the processor 100 into the I/O buffer 118 of the port 116, and in the case of an output operation this means supplying data in the I/O buffer 118 from the port 116 to the exterior of the processor 100.

Note that in embodiments, there may be provided additional counter circuitry 107 for supplying different counter values to a port 116 than supplied to the execution unit 102, such that the value c′ used by the SETPT instruction is not necessarily the same value c used by the ELATE instruction. The additional counter may be clocked by a different clock signal than the wall clock counter 106 (the clock circuitry 108 may contain multiple PLLs and/or dividers, or be connected to multiple crystals 190, for generating different clock signals for supply to different parts of the chip 100). In particularly preferred embodiments, there may be provided circuitry for assigning different counter values to different ports.

The SETPT instruction sets the trigger time register 120 of a port 116 identified by the first argument r to the value of the second argument s. This means that the next I/O operation will be triggered to occur at time s, relative to the clock c′ supplied to port r.

Furthermore, the trap-if-late logic 124 is configured, when executing the SETPT instruction, to raise an exception if the counter value c′ associated with the port 116 identified by the first argument r has already gone beyond the time indicated by the second argument s.

The SETPT instruction described above is similar to the ELATE instruction in that it detects whether the point in the program at which that instruction itself occurs is late.

However, in embodiments, an alternative or additional action may be associated with the SETPT instruction (and or with a further type of trap-if-late instruction). That is, the trap-if-late logic 124 may alternatively or additionally be configured to store the argument s of a trap-if-late instruction such as SETPT in a deadline register (not shown) in the trap-if-late logic 124, in order to set up a stored target time value which is then compared to the counter c′ at a later point in the code. That is, even if the current time c′ is not late compared to s at the time of execution of the SETPT, then the trap-if-late logic may be configured to continue to compare the stored time s with the counter c′ while the rest of the program continues to run, and to raise an exception at the stored target time s if an output from the relevant port r has not been performed by that stored target time s. In that case, an output instruction of the form:

### OUT r, d

would also have a special function of clearing the deadline register (or clearing an associated flag). Alternatively, the trap-if-late logic 124 could be configured to act on the OUT instruction itself, to perform the comparison between c′ and s in response to executing the OUT so as to generate the exception (if warranted) at the point of execution of the attempted OUT instruction.

It will be appreciated that the above embodiments have been described only by way of example.

For instance, in embodiments the execution logic determines whether the counter value c is after than the argument s. However, it will be appreciated that a less preferred variant (requiring slightly more logic) would be to generate an exception if the counter value c is on or after the argument s (i.e. such that the argument represents a time at which it would already be too late). For the avoidance of doubt it will be noted that either case could fall under wording such as “generating an exception on condition that the counter value represents a time that is late relative to said argument value.”

Further, the invention is not limited to use in a development environment with a test platform 150 and host terminal 150. The present invention could also be used “in the field” to generate exceptions in a real-life user application, to resort to some exception handling routine if a part of the program was running too slowly during use by the user.

Other applications and configurations of the present invention may be apparent to a person skilled in the art given the disclosure herein. The present invention is not limited by the described embodiments, but only by the appendant claims.

1. A processor comprising:
an execution unit arranged to execute a sequence of instructions each comprising a respective opcode; and
a counter coupled to the execution unit and arranged to generate a periodically updated counter value during said execution;
wherein the execution unit comprises logic configured to identify an opcode representing a trap-if-late instruction in said sequence, and in response to execute the trap-if-late instruction by comparing a target value to the counter value and generating an exception on condition that the counter value represents a time that is late relative to said target value.

2. The processor of claim 1, wherein said logic is configured to determine the target value from an operand of said trap-if late instruction.

3. The processor of claim 1, wherein the identity of the counter is implicit in the trap-if-late instruction.

4. The processor of claim 2 and 3, wherein the trap-if-late instruction has a single operand.

5. The processor of claim 1, wherein the counter is arranged to generate a counter value representing time in discrete units of seconds or integer divisions of seconds.

6. The processor of claim 1, wherein said logic is configured to generate the exception at the point of execution of said trap-if-late instruction itself, on condition that the counter value represents a time that is late relative to said target value at that point of execution.

7. The processor of claim 1, wherein said logic is configured, in response to the trap-if-late instruction, to store said target value for subsequent comparison with the counter value, and to generate an exception at a later point in the code if a further operation has not been executed by that point.

8. The processor of claim 1, wherein the trap-if-late instruction is a set-port instruction which sets a time register of a port to said target value such that a transfer of data involving said port will occur at a time corresponding to the target value.

9. The processor of claim 7 and 8, wherein said further operation comprises an output of data from said port.

10. The processor of claim 1, wherein the execution unit is configured to execute an instruction set which includes:
a first trap-if-late instruction, and
a second trap-if-late instruction having a different opcode from the first trap-if-late instruction, wherein the second trap-if-late instruction is a set-port instruction which sets a time register of a port to said target value such that a transfer of data involving said port will occur at a time corresponding to the target value.

11. The processor of claim 1, wherein said logic is configured to perform said comparison by means of an operation to determine whether the counter value is greater than said argument value.

12. The processor of claim 1, wherein said logic is configured to perform said comparison by means of an operation to determine whether a signed difference between the counter value and the operand is greater than zero.

13. The processor of claim 1, comprising a debugging port, wherein the processor is arranged to output an indication of the exception via the debugging port.

14. A system comprising the processor according to claim 13 and a separate computer terminal, wherein the computer terminal is coupled to said debugging output and arranged to detect said exception.

15. A system comprising: a processor according to claim 1, and a separate computer terminal for generating said sequence of instructions for execution on said processor; wherein the computer terminal comprise a compiler configured generate said sequence of instructions from higher-level code and to insert said trap-if-late instruction into the sequence in response to a timing constraint in the higher-level code.

16. The system of claim 15, wherein the timing constraint is explicitly specified in said higher-level code by a programmer.

17. The system of claim 15, wherein the compiler is configured to detect whether a portion of said higher-level code qualified by said timing constraint is dependent on non-deterministic data, and to insert the trap-if-late instruction on condition of detecting that the portion is dependent on non-deterministic data.

18. A compiler product embodied on a computer-readable medium, the compiler being configured so as when run on a computer terminal to:
receive higher-level code, and compile the high-level code to generate lower-level code;
identify a timing constraint in said higher-level code; and
in response to the identification of said timing constraint, insert a trap-if-late instruction into the lower-level code, the trap-if-late instruction comprising an opcode identifying the instruction as a trap-if-late instruction, the opcode being configured to operate an execution unit of a target processor to compare a target value to the counter value and generate an exception on condition that the counter value represents a time that is late relative to said argument.

19. The compiler product of claim 18, wherein the compiler is configured to identify a timing constraint explicitly specified in the high-level code by a programmer, and to insert said trap-if-late instruction in response to the explicit timing constraint.

20. The compiler product of claim 18, wherein the compiler is configured to detect whether a portion of said higher-level code qualified by said timing constraint is dependent on non-deterministic data, and to insert the trap-if-late instruction on condition of detecting that the portion is dependent on non-deterministic data.

21. A method of executing a sequence of instructions on a processor, each instruction comprising a respective opcode, the method comprising:
periodically updating a counter value during said execution; and
operating an execution unit to identify an opcode representing a trap-if-late instruction in said sequence, and in response executing the trap-if-late instruction by comparing a target value to the counter value and generating an exception on condition that the counter value represents a time that is late relative to said target value.

22. The method of claim 21, comprising operating said execution unit to determine the target value from an operand of said trap-if late instruction.

23. The method of claim 21, comprising determining the identity of the counter implicitly from the trap-if-late instruction.

24. The method of claim 22 and 23, wherein the trap-if-late instruction has a single operand.

25. The method of claim 21, wherein the counter value is generated so as to represent time in discrete units of seconds or integer divisions of seconds.

26. The method of claim 21, comprising operating said execution unit to generate the exception at the point of execution of said trap-if-late instruction itself, on condition that the counter value represents a time that is late relative to said target value at that point of execution.

27. The method of claim 21, comprising operating said execution unit, in response to the trap-if-late instruction, to store said target value for subsequent comparison with the counter value, and to generate an exception at a later point in the code if a further operation has not been executed by that point.

28. The method of claim 21, wherein the trap-if-late instruction is a set-port instruction which sets a time register of a port to said target value such that a transfer of data involving said port will occur at a time corresponding to the target value.

29. The method of claim 21, wherein said further operation comprises an output of data from said port.

30. The method of claim 21, comprising operating said execution unit to execute an instruction set which includes:
a first trap-if-late instruction, and
a second trap-if-late instruction having a different opcode from the first trap-if-late instruction, wherein the second trap-if-late instruction is a set-port instruction which sets a time register of a port to said target value such that a transfer of data involving said port will occur at a time corresponding to the target value.

31. The method of claim 21, wherein said comparison comprises determining whether the counter value is greater than said argument value.

32. The method of claim 21, wherein said comparison comprises determining whether a signed difference between the counter value and the operand is greater than zero.

33. The method of claim 21, comprising outputting an indication of the exception via a debugging port of the processor.

34. The method of claim 33, comprising outputting said exception via the debugging port to a separate computer terminal, and detecting the exception at that computer terminal.

35. A method of claim 21, comprising generating said sequence of instructions from higher-level code using a compiler run on a separate computer terminal, and operating the compiler to insert said trap-if-late instruction into the sequence in response to a timing constraint in the higher-level code.

36. The method of claim 35, wherein the timing constraint is explicitly specified in said higher-level code by a programmer.

37. The method of claim 35, comprising operating the compiler to detect whether a portion of said higher-level code qualified by said timing constraint is dependent on non-deterministic data, and to insert the trap-if-late instruction on condition of detecting that the portion is dependent on non-deterministic data.
